(19) United States
(12) Patent Application Publication
(10) Pub. No.: US 2011/0187284 A1
(43) Pub. Date: Aug. 4, 2011

(54) APPARATUS AND METHOD CAPABLE OF CHANGING ILLUMINATION REGION

(76) Inventor: Jiayou Liu, Taiwan (CN)

(21) Appl. No.: 12/997,075

(22) PCT Filed: Oct. 15, 2008
(86) PCT No.: PCT/CN2008/001737

§ 371 Date: Dec. 9, 2010

(51) Int. Cl. H05B 37/02

(52) U.S. Cl. 315/294

(57) ABSTRACT

An apparatus capable of changing a size of illumination region is disclosed. The apparatus comprises a first optical unit, a second optical unit, a first driving element, and a second driving element. The first optical unit is composed of a first LED and a first optical element. The second optical unit is composed of a second LED and a second optical element. The driving elements selectively provide different driving currents to different LEDs for changing the luminance of the illumination field. A first illumination region can be formed when the first and second driving elements respectively provide the first and second driving currents to the first and second LEDs. A second illumination region can be formed when the first and second driving elements respectively provide the third and fourth driving currents to the first and second LEDs. The first illumination region is different from the second illumination region.

### CROSS REFERENCE TO RELATED APPLICATION

This application is the 35 U.S.C. §371 national stage of PCT application PCT/CN2008/001737, filed Oct. 15, 2008, the disclosure of which is hereby incorporated by reference.

### BACKGROUND OF THE INVENTION

1. Field of the Invention

The invention relates in general to an illumination apparatus, and more particularly to an apparatus and method capable of changing illumination region.

2. Description of the Related Art

The illumination apparatuses currently available in the market have various emitting angles for the user to select. The user can purchase suitable illumination apparatus to meet particular needs. For a small picture on the wall, an illumination apparatus having a small emitting angle is used so that the illumination region can be focused on the small picture. For a large picture, an illumination apparatus having a large emitting angle is used so that the illumination region can be focused on the large picture.

If the illumination region changes, the user has to purchase another illumination apparatus having a different emitting angle in response to such change. If the illumination apparatus is installed at a high position, the replacement of illumination apparatus becomes more difficult.

An illumination apparatus, which changes the emitting angle and the illumination region by enlarging/reducing the light beam through the adjustment of the distance between the two lenses in front of the light source, is disclosed in the U.S. Pat. Nos. 4,101,957, 5,584,568 and 6986593. However, the transmissive optical element tends to result in loss of large-angle lights and deterioration in efficiency. U.S. Pat. No. 4,855,884 discloses a design which changes the illumination region by opening/covering the reflective surface through a reflective lens capable of changing curvature and driven by a motor. Such design is very complicated in terms of mechanism. Also, the above two methods both change the size of illumination region through the control of optical elements driven by a motor, hence causing more difficulty to the assembly of elements.

According to the United States Patent Publication No. 20070091602, several LEDs and corresponding lens sets may result in different distributions of illumination field (for example, the maximum luminance may be located at the center or the edges) and make the distribution of the illumination field as ring-shaped, and the desired size of illumination region can be formed by stacking several illumination fields. However, this patent adopts transmissive optical elements and tends to result in loss of large-angle lights and deterioration in efficiency.

### SUMMARY OF THE INVENTION

The invention is directed to a method and an apparatus for controlling the size of illumination region by changing the driving current inputted to the light emitting diodes (LEDs).

According to a first aspect of the present invention, an apparatus capable of changing the size of illumination region is disclosed. The apparatus comprises a first optical unit, a second optical unit, a first driving element, and a second driving element. The first optical unit includes a first LED and a first optical element and is used for producing a first light beam which has a first emitting angle and the first light beam forms a first illumination field whose maximum luminance is in the central area. The second optical unit includes a second LED and a second optical element and is used for producing a second light beam which has a second emitting angle and the second light beam forms a second illumination field whose maximum luminance is in the central area. The first driving element selectively provides a first driving current or a third driving current to the first LED for changing the luminance of the first illumination field. The second driving element selectively provides a second driving current or a fourth driving current to the second LED for changing the luminance of the second illumination field. A first illumination region is formed when the first driving element provides the first driving current to the first LED and the second driving element provides the second driving current to the second LED. A second illumination region is formed when the first driving element provides the third driving current to the first LED and the second driving element provides the fourth driving current to the second LED. The first illumination region is different from the second illumination region.

According to a second aspect of the present invention, a method for controlling the size of illumination region is provided. The method includes the following steps: A first illumination region is selected. A first driving current set corresponding to the first illumination region is located from a micro-controller, wherein the first driving current set comprises a first driving current and a second driving current. The first driving current is provided to a first optical unit by a first driving element according to the first driving current set, so that the first optical unit produces a first light beam which has a first emitting angle and the first light beam forms a first illumination field whose maximum luminance is in the central area. The second driving current is provided to a second optical unit by a second driving element, so that the second optical unit produces a second light beam which has a second emitting angle and the second light beam forms a second illumination field whose maximum luminance is in the central area. A second illumination region is selected. A second driving current set corresponding to the second illumination region is located from the micro-controller, wherein the second driving current set comprises a third driving current and a fourth driving current. The third driving current is provided to the first optical unit by the first driving element according to the second driving current set, so that the first optical unit produces a third light beam which has the first emitting angle and the third light beam forms a third illumination field whose maximum luminance is in the central area. The fourth driving current is provided to the second optical unit by the second driving element, so that the second optical unit produces a fourth light beam which has the second emitting angle and the fourth light beam forms a fourth illumination field whose maximum luminance is in the central area. The first illumination field and the second illumination field form the first illumination region. The third illumination field and the fourth illumination field form the second illumination region.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows an illumination apparatus of the invention.

FIGS. 2 A and 2B show a distribution chart of optical field formed by the first optical unit and the second optical unit respectively.

FIGS. 3A-3C show an optical field distribution chart according to an embodiment of the invention.

FIG. 4 shows a control circuit diagram.

FIG. 5 shows a worksheet.

FIGS. 6A-6C show an optical field distribution diagram of illumination regions corresponding to the worksheet of FIG. 5.

### DETAILED DESCRIPTION OF THE INVENTION

Normally, the user must change the positions of the bulbs or lamps having different emitting angles in order to change the size of illumination region, and this is indeed very inconvenient to the user. However, if the size of illumination region can be changed by controlling the magnitude of the driving current inputted to the light emitting diodes (LEDs) without changing the illumination apparatus, it would be more convenient to the user and both the cost and installation risk will be reduced.

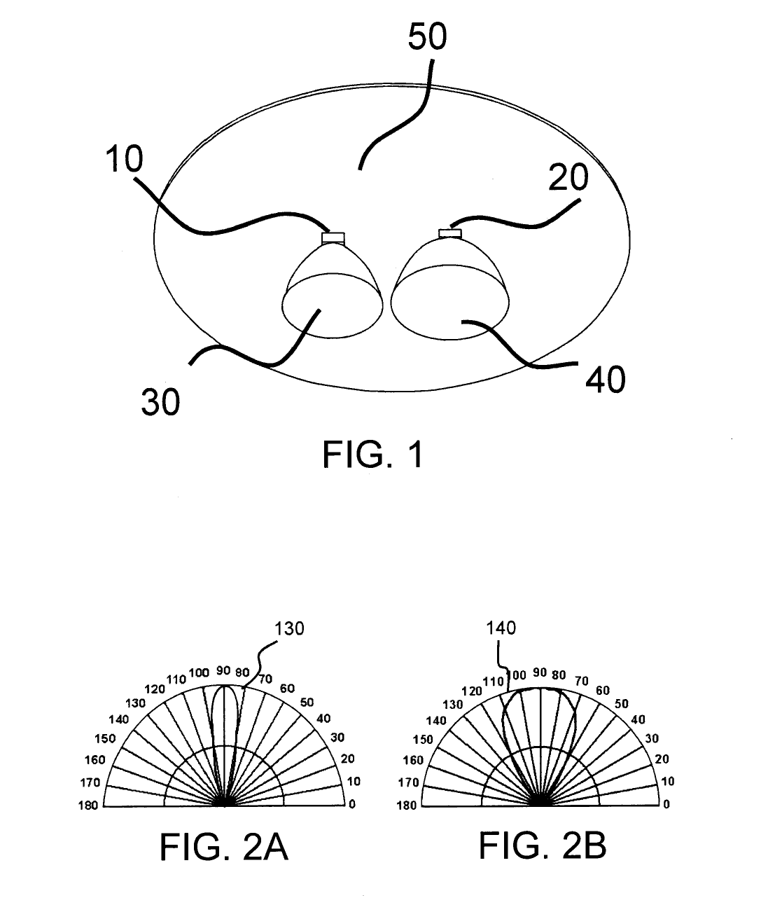

Referring to FIG. 1, an illumination apparatus of the invention is shown. The illumination apparatus comprises two LEDs 10 and 20, two optical elements 30 and 40 and a control circuit board 50. As indicated in FIG. 1, the first optical element 30 and the second optical element 40 are optical masks with different levels of curvature. Thus, the optical properties generated by the first optical unit composed of the first LED 10 and the first optical element 30 are different from that generated by the second optical unit composed of the second LED 20 and the second optical element 40. Examples of the optical properties include the variation of emitting angle and the ring-shaped distribution of optical field. The optical elements can be realized by different lens sets in addition to the optical masks having different levels of curvature to achieve different optical properties.

Referring to FIG. 2A, a distribution chart of emitting angle of the first optical unit is shown. It is obvious that the emitting angle 130 of the first optical unit is 20°. Referring to FIG. 2B, a distribution chart of emitting angle of the second optical unit is shown. It is obvious that the emitting angle 140 of the second optical unit is 60°. However, the emitting angles are not limited to 20° and 60°, different emitting angles can be used to meet different designs. And the emitting angles of the two optical units are not the same, thus, the first optical unit and the second optical unit can be combined to form the illumination apparatus capable of changing illumination region of the invention.

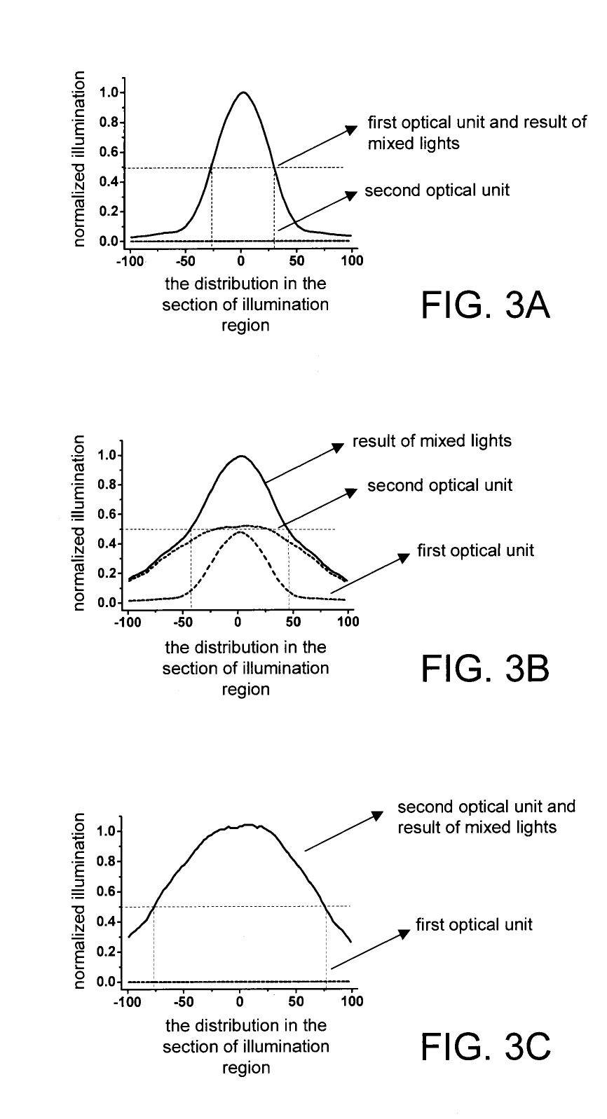

Referring to FIGS. 3A to 3C, a first embodiment of controlling the illumination region by changing the luminance levels of the first optical unit and the second optical unit are shown. FIG. 3A shows the distribution of normalized illumination of the first optical unit and the second optical unit in the section of illumination region when a first driving element provides 1 unit of current to the first optical unit but a second driving element does not provide any current to the second optical unit. The first and second driving elements are in the control circuit board 50. After the light is mixed, the radius of the distribution of the mixed light in the section of illumination region at a position 1.5 m afar is 25 cm. FIG. 3B shows the distribution of normalized illumination of the first optical unit and the second optical unit in the section of illumination region when the first driving element provides 0.5 unit of current to the first optical unit and the second driving element provides 2.13 units of current to the second optical unit. After the light is mixed, the radius of the distribution of the mixed light in the section of illumination region at a position 1.5 m afar is 45 cm. FIG. 3C shows the distribution of normalized illumination of the first optical unit and the second optical unit in the section of illumination region when the first driving element does not provide any current to the first optical unit and the second driving element provides 4.21 units of current to the second optical unit. After the light is mixed, the radius of the distribution of the mixed light in the section of illumination region at a position 1.5 m afar is 76 cm.

According to the above disclosure, when different magnitudes of current are provided to the first optical unit and the second optical unit, the invention can achieve the effect that the luminance levels are the same but the illumination regions are different. That is, to achieve the illumination region desired by the user, the driving currents provided to the LEDs of the first optical unit and the LEDs of the second optical unit are different.

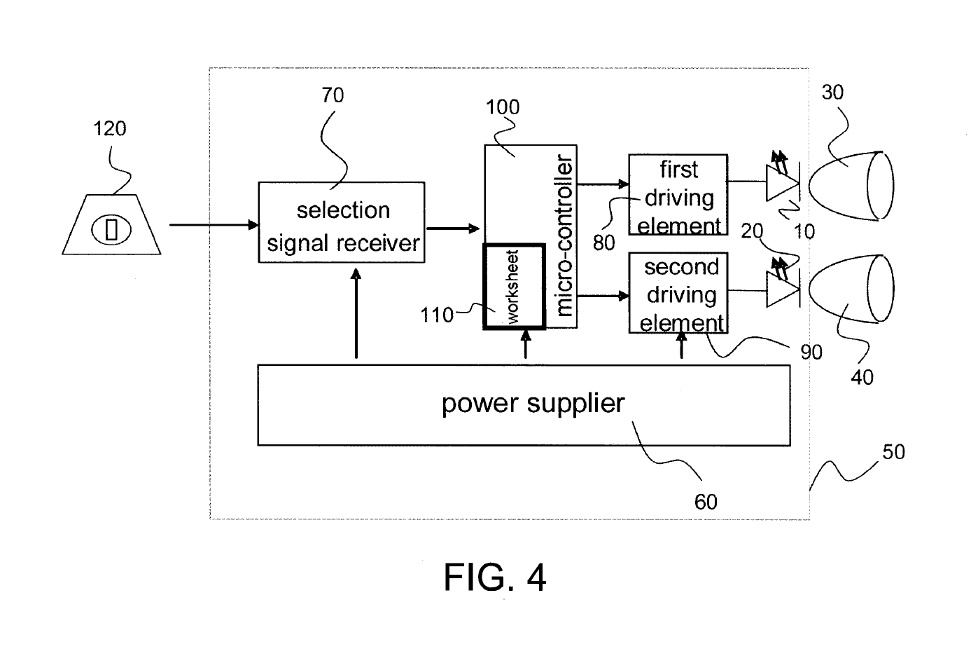

Referring to FIG. 4, a control circuit board of an illumination apparatus is shown. To achieve the effect of having the same level of luminance but different illumination regions, a worksheet 110 is disclosed in the invention. The worksheet 110 comprises the first driving current and the second driving current corresponding to various illumination regions. The control circuit board comprises a power supplier 60, which provides power to a selection signal receiver 70, a micro-controller 100 and two LED driving elements 80 and 90. The selection signal receiver 70 receives a selection signal inputted from a selection device 120 and further transforms the selection signal into a control signal which is further transmitted to the micro-controller 100. The micro-controller 100 checks the worksheet 110 to obtain a corresponding driving signal according to the received control signal and further transmits the corresponding driving signal to the driving elements 80 and 90. After receiving the driving signal, the two driving elements 80 and 90 immediately generate a corresponding driving current and further input the driving current to corresponding LEDs 10 and 20. The user selects the required size of illumination region with the selection device 120, which immediately transmits a selection signal to the selection signal receiver 70. After receiving the selection signal, the selection signal receiver 70 transmits a control signal to the micro-controller 100. The micro-controller 100 locates a corresponding driving current value from the worksheet 110 according to the received control signal, and further transmits corresponding driving signals to corresponding driving elements 80 and 90 respectively. After receiving the driving signals, the driving elements 80 and 90 respectively output corresponding driving currents to corresponding LEDs 10 and 20, so that the LEDs 10 and 20 can emit a light respectively. After the lights emitted by LEDs 10 and 20 pass through corresponding optical elements 30 and 40, the lights will possess different optical properties. After the lights are mixed at a distant illumination position, the size of illumination region desired by the user will be obtained accordingly.

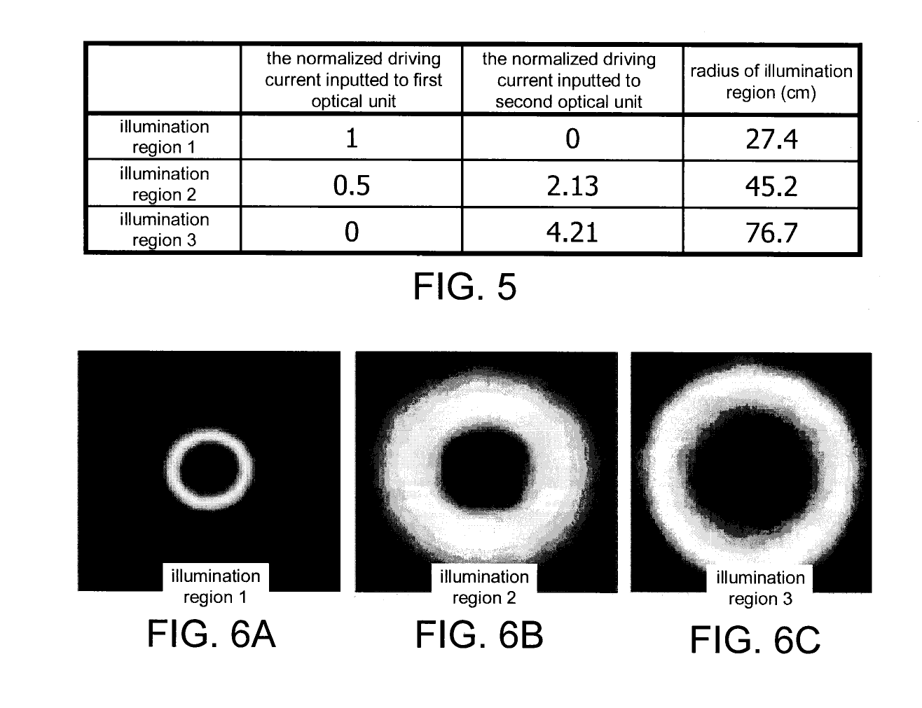

Referring to FIG. 5, a worksheet 110 is shown. The worksheet is stored in a read only memory. As indicated in FIG. 5, when the illumination region 1 is selected, a corresponding driving current set is searched from the worksheet 110. The normalized driving current inputted to the first optical unit is 1 unit, and the normalized driving current inputted to the second optical unit is 0 unit. After the corresponding driving currents are respectively inputted to corresponding LEDs 10 and 20 and the emitted lights are mixed in the illumination region, an optical field distribution diagram in which the radius of the illumination region is equal to 27.4 cm is obtained, and the optical field distribution diagram is indicated in FIG. 6A. Similarly, when the illumination region 2 or the illumination region 3 is selected, a corresponding driving current set will also be located from the worksheet 110, and after the corresponding driving currents are inputted to corresponding LEDs 10 and 20, the desired size of illumination region can be obtained, and the optical field distribution diagrams are indicated in FIG. 6B and FIG. 6C. In addition, the current changes between two driving current sets are continuous so that the size change of the illumination region is smooth and continuous.

Moreover, the driving current set can be stored in the worksheet or directly controlled by a firmware, which simulates the relationship between the driving current set and the size of illumination region as a formula below:

y1=ax+b, y2=cx+d,

wherein y1 and y2 denote the driving currents to be outputted to corresponding optical units, and x denotes a feedback signal. When the user adjusts the size of illumination region, a feedback signal is transmitted to the micro-controller, which further outputs a driving current to a corresponding optical unit according to the feedback signal. The firmware provides a program which enables the micro-controller to make response when receiving a feedback signal.

The illumination apparatus of the invention has the advantage of changing the size of illumination region without using a motor mechanism, and further has the advantages of reducing volume and increasing light emitting efficiency.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An apparatus capable of changing a size of illumination region, comprising:
a first optical unit including a first light emitting diode (LED) and a first optical element and used for producing a first light beam which has a first emitting angle and the first light beam forms a first illumination field whose maximum luminance is in the central area;
a second optical unit including a second LED and a second optical element and used for producing a second light beam which has a second emitting angle and the second light beam forms a second illumination field whose maximum luminance is in the central area;
a first driving element selectively providing a first driving current or a third driving current to the first LED for changing a luminance of the first illumination field; and
a second driving element selectively providing a second driving current or a fourth driving current to the second LED for changing a luminance of the second illumination field;
wherein, a first illumination region is formed when the first driving element provides the first driving current to the first LED and the second driving element provides the second driving current to the second LED, a second illumination region is formed when the first driving element provides the third driving current to the first LED and the second driving element provides the fourth driving current to the second LED, and the first illumination region is different from the second illumination region.

2. The apparatus capable of changing the size of illumination region according to claim 1, wherein the first illumination region and the second illumination region have the same level of luminance.

3. The apparatus capable of changing the size of illumination region according to claim 1, wherein the first optical element and the second optical element are deflective or reflective optical element.

4. The apparatus capable of changing the size of illumination region according to claim 1, wherein the first driving current and the second driving current are a first driving current set, the third driving current and the fourth driving current are a second driving current set, and the first and second driving current sets are stored in a worksheet in advance.

5. The apparatus capable of changing the size of illumination region according to claim 4, wherein the worksheet is stored in a read only memory in advance.

6. The apparatus capable of changing the size of illumination region according to claim 1, wherein the first driving current and the second driving current are a first driving current set, the third driving current and the fourth driving current are a second driving current set, and the first and second driving current sets are controlled by a micro-controller according to a firmware.

7. The apparatus capable of changing the size of illumination region according to claim 6, micro-controller makes response when receiving a feedback signal corresponding to the change of illumination regions.

8. The apparatus capable of changing the size of illumination region according to claim 1, wherein the first driving current is continuously changed to the third driving current and the second driving current is continuously changed to the fourth driving current.

9. The apparatus capable of changing the size of illumination region according to claim 1, wherein the first emitting angle is smaller than the second emitting angle.

10. A method for controlling a size of illumination region, wherein the method comprises the following steps:
selecting a first illumination region;
locating a first driving current set corresponding to the first illumination region from a micro-controller, wherein the first driving current set comprises a first driving current and a second driving current;
providing the first driving current to a first optical unit by a first driving element according to the first driving current set, so that the first optical unit produces a first light beam which has a first emitting angle and the first light beam forms a first illumination field whose maximum luminance is in the central area;
providing the second driving current to a second optical unit by a second driving element, so that the second optical unit produces a second light beam which has a second emitting angle and the second light beam forms a second illumination field whose maximum luminance is in the central area;
selecting a second illumination region;
locating a second driving current set corresponding to the second illumination region is located from the micro-controller, wherein the second driving current set comprises a third driving current and a fourth driving current;
providing the third driving current to the first optical unit by the first driving element according to the second driving current set, so that the first optical unit produces a third light beam which has the first emitting angle and the third light beam forms a third illumination field whose maximum luminance is in the central area; and
providing the fourth driving current to the second optical unit by the second driving element, so that the second optical unit produces a fourth light beam which has the second emitting angle and the fourth light beam forms a fourth illumination field whose maximum luminance is in the central area;
wherein, the first illumination region is formed by the first illumination field and the second illumination field, and the second illumination region is formed by the third illumination field and the fourth illumination field.

11. The method for controlling the size of illumination region according to claim 10, wherein the first illumination region and the second illumination region have the same level of luminance.

12. The method for controlling the size of illumination region according to claim 10, wherein the first optical unit is includes a first LED and a first reflective optical element, and the second optical unit includes a second LED and a second reflective optical element.

13. The method for controlling the size of illumination region according to claim 10, wherein the micro-controller chooses the first and second driving current sets when receiving a feedback signal corresponding to the change of illumination regions.

14. The method for controlling the size of illumination region according to claim 13, wherein a worksheet is stored in a read only memory in advance and the worksheet contains the values of the first, second, third and fourth driving currents.

15. The method for controlling the size of illumination region according to claim 10, wherein the first driving current is continuously changed to the third driving current and the second driving current is continuously changed to the fourth driving current.
